(19) United States
(12) Patent Application Publication
(10) Pub. No.: US 2016/0205102 A1
(43) Pub. Date: Jul. 14, 2016

(54) Secure Remote Authentication of Local Machine Services Using a Self Discovery Network Protocol

(71) Applicant: Spyrus, Inc., San Jose, CA (US)

(72) Inventors: Michael Perretta, San Jose, CA (US); Burton Tregub, Encino, CA (US)

(73) Assignee: Spyrus, Inc., San Jose, CA (US)

(21) Appl. No.: 14/991,114

(22) Filed: Jan. 8, 2016

Related U.S. Application Data
(60) Provisional application No. 62/101,961, filed on Jan. 9, 2015.

(51) Int. Cl. H04L 29/06

(52) U.S. Cl. CPC H04L 63/10; H04L 63/083; H04L 63/0428

(57) ABSTRACT

A method for secure remote authentication of a computing device over a network that uses a communications protocol which does not require use of an address, and on which one or more authentication servers are listening, comprising the steps of broadcasting a unique identifier over the network; accepting a request over the network from one of the one or more authorization servers to initiate an authentication protocol; responding to the request; receiving data necessary to complete a boot process; and completing a boot process using the received data.

This application claims the benefit of and incorporates by reference the text of U.S. Provisional Patent Application No. 62/101,961, filed Jan. 9, 2015, titled “Secure Remote Authentication of Local Machine Services Using a Self Discovery Network Protocol.”

### FIELD OF INVENTION

The field of the invention is the secure boot-up of computing devices over a network and more specifically to methods and systems for secure authenticated log-on of computing devices during a boot sequence, in which a passcode to complete boot-up must be obtained from one or more servers which are listening on the network.

### BACKGROUND

The Internet has served as a disruptive technology among both social worlds and machine worlds, introducing new freedoms of access to information and remote control of devices. Innovations in mobile and industrial use of the Internet have been employed to access devices that are embedded within other systems and may be accessed and controlled remotely. This has developed into a market for the Internet of Things “IoT”, which comprises computing devices that use the Internet as the communications transmission medium for collecting, transmitting and receiving data to control processes within the device, for example, home thermostats, medical instrumentation, controllers of pipelines and energy systems, and self-driving vehicles, to name only a few embodiments. The growth of disruptive Internet and communications technologies, however, introduces new threats to critical infrastructures implicating privacy, security, safety, and interoperability. Quite simply, the large number of computing devices connected through the Internet is a tantalizing target for hackers.

The growth of process control and monitoring of computing devices on the IoT, or more generally on any network, is characterized by an increasing number operating in a headless mode with no attachment to a human interface device such as a keyboard, display, or mouse; and therefor having no human intervention in their functioning. The problem of managing such computing devices is exacerbated not only by their growing ubiquity, but by their headless operation. For convenience, these headless computing devices are referred to herein as “HCD” (or in the plural as “HCDs”), but it will be readily apparent to one skilled in the art that such headless state is just a description and not a necessary condition for practice of the invention. In other words, HCD refers to a computing device, regardless of the presence, or lack thereof, of input means.

Cybercriminals have been known to insert latent malicious code into an HCD operating system, thereby allowing the malicious code opportunistic entry into the HCD's programs during the next reboot of the operating system. In order to thwart such attacks it is possible to place a clean copy of the operating system on a separate drive, preferably having a form factor of a USB flash drive, or within a Trusted Computing Base within the HCD itself. When that is done, however, it is advantageous to also have the external or internal drive encrypted and protected by a passcode. One example of an external encrypting flash drive with an operating system on-board is the WorkSafe Pro™ bootable Windows To Go™ flash drive from SPYRUS, Inc.

Encrypting flash drives and encryption protected Trusted Computing Bases are also useable in computation-intensive system process control applications in manufacturing, robotics and pharmaceutical plants and surveillance and monitoring applications in nuclear facilities or military operations where networks of HCDs may contain highly sensitive information or programs. All that is necessary, then, is to enter the appropriate passcode at reboot to permit the HCD to load a safe copy of the operating system or gain access to required confidential data or programs.

To minimize the opportunity window of potential vulnerability the HCD preferably remains off-line, and performs a reboot and reload of its operating systems and application programs and data when it comes on-line, either in response to a local command (such as turning on the local device) or command from a remote control center. Either case, however, requires entry of the required passcode to unlock the protected operating system and stored data.

Storage of the passcode in the clear on an HCD in either hardware or software is not an option, and because HCDs are often placed in hostile or dangerous high-risk environments, use of the Internet as the transmission medium to “reach back” to communicate with a remote command center in order to receive the passcode is risky.

Communicating with one or more remote control centers is also difficult because storing the IP address of one or more remote command centers at the HCD is inadvisable (as it exposes the remote centers to attack) or impracticable (as the information would be ephemeral and unavailable before reboot is complete). Manually entering the passcode at the local HCD is also not an option, either because the HCD lacks any input means, or requiring operator intervention is infeasible (due to the multiplicity of devices, or otherwise).

The ease of access to the Internet, for example by any of billons of smartphones or computers, has lowered any barrier to malicious cyberattacks on any computing and communications devices using the Internet for a transmission medium, many of which are part of critical infrastructures around the globe, including smart grid power systems, communications systems, manufacturing plants and hospital operating and patient recovery rooms. Cisco, Inc., predicts there will be 50 billion devices connected to the Internet by 2020 and that the global IoT economic value will be $19 trillion for companies and industries worldwide in the next decade. Across health-care applications, Internet of Things technology could have an economic impact of $1.1 trillion to $2.5 trillion per year by 2025.

The Center for Strategic and International Studies 2014 estimates that cyberattacks funded by nation-states with basically unlimited economic and technology resources can also account for the loss of 350,000 jobs in the U.S. and Europe. Worse yet, the threats to national security from attacks on IOT devices that will be used to control power grids, pipelines, communications systems, banking systems, and transportation vehicles represents threats to national security that are too devastating to be measured. Breaches can be executed by adversaries from all quarters. According to a 2014 study cyberattacks cost the global economy about $445 billion.

Therefore, there is a need for a method to maintain security while transmitting passcode information to HCDs from one or more remote servers.

### SUMMARY

The invention meets this need by providing a method for secure downloading of authentication passwords to multiple HCDs using a broadcast communication protocol which permits each HCD to securely communicate with any one of multiple servers.

### BRIEF DESCRIPTION OF DRAWINGS

FIG. 1A is a flow diagram of one embodiment of the method of the invention.

FIG. 1B is a flow diagram of another embodiment of the method of the invention.

FIG. 2 is a schematic for one embodiment of secure remote authentication according to the invention.

### DETAILED DESCRIPTION

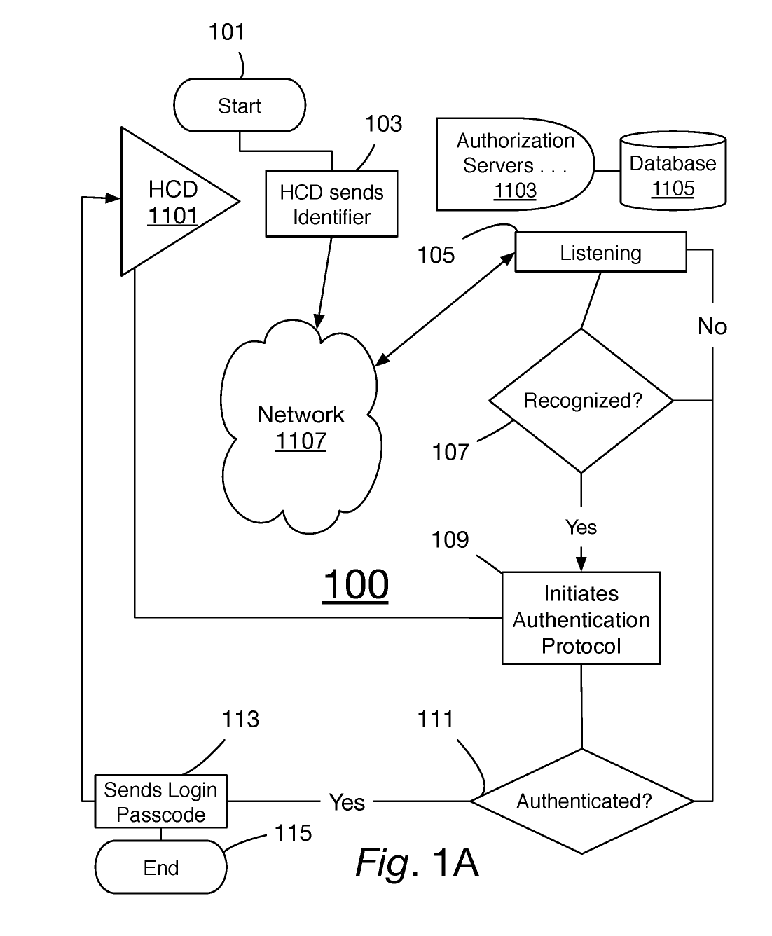

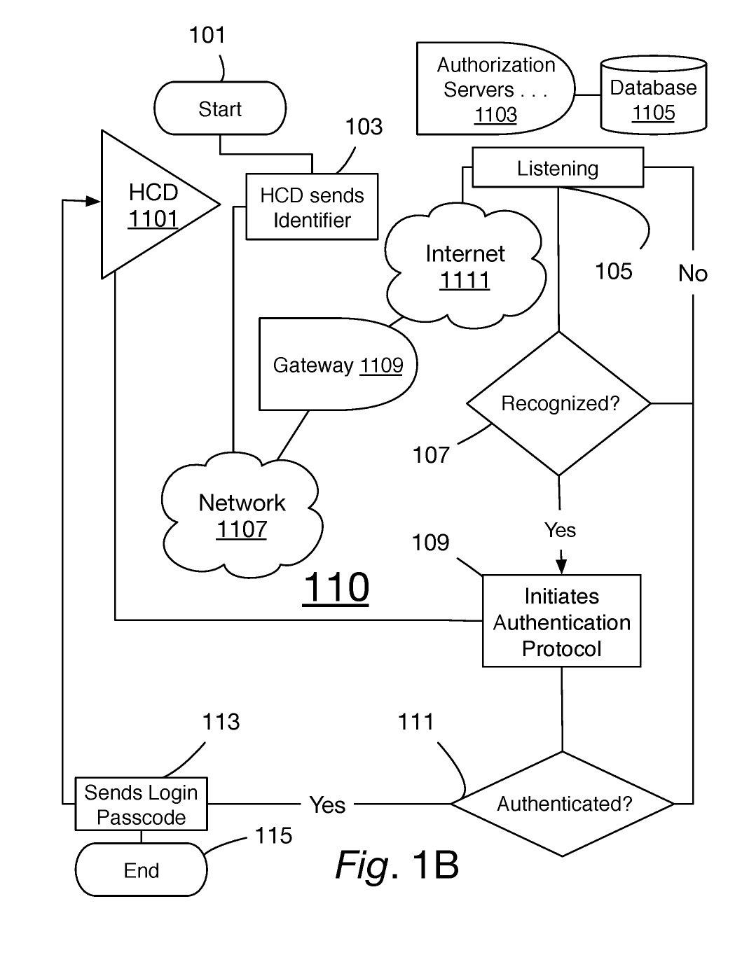

The method of the invention will first be described, with reference to FIG. 1. Specific embodiments will then be described. These are not meant to narrow the generality of the invention, which is usable with a broad range of devices, protocols, and circumstances.

Because an HCD may not “know” the IP address of the remote control center, a means of broadcast over a network 1107 using a protocol which does not require knowledge of IP addresses is required (here a “self discovery network protocol”). Currently, one such protocol which meets this requirement is the User Diagram Protocol defined by RFC 768 written by John Postel and known as UDP, although other protocols may be used or be developed in the future which do not require knowledge of IP addresses and thus be usable with the invention, as will be evident to one of ordinary skill in the art with reference to this disclosure.

As explained above, the acronyms “HCD” and “HCDs” are meant to refer to computing devices whether or not they in fact have input means. This will also be apparent to one of ordinary skill with reference to this disclosure. In other words, being “headless” is not a necessary condition for the invention.

With reference to FIG. 1A, the method 100 begins in step 101 and in step 103 the HCD 1101 broadcasts a packet over network 1107 using a self discovery network protocol, the packet containing a unique identifier. For example, such unique identifier could be selected from a group of unique data consisting of a session nonce, the serial number or other machine “fingerprint” data, a network authentication code, and the public key of the HCD, or a hash of thereof, or of any combination. Other unique identifiers are possible, as will be evident to one skilled in the art. In Step 105 one or more authentication servers 1103 each having a database 1105 listen to incoming packets and in step 107 when the identifier information matches an entry in their database they recognize the HCD and accept the packet and proceed to step 109, and otherwise no not recognize the HCD, reject the packet, and return control to the listening step 105.

In step 109 the authentication protocol may be as extensive as the circumstance requires. For example, the HCD 1101 can contain a known fixed key and a random challenge can be preformed by the authorization server 1103. It can also employ a unique key pair that the authorization server knows the HCD is in possession of. If the HCD does not have the private key the authentication will fail.

If successful, the HCD is authenticated and in step 113 may receive the passcode needed to complete the boot process and access protected data. In a further embodiment, the authentication server may transmit other protected data to the HCD in step 113, in addition to the login passcode.

In a still further embodiment 110 of the method, with reference to FIG. 1B, a gateway 1109 which knows the IP address of the authorization servers 1103 is listening on network 1107, and it rebroadcasts the packets over the Internet 1111 using any one of available IP protocols, to the known address of the one or more authorization servers.

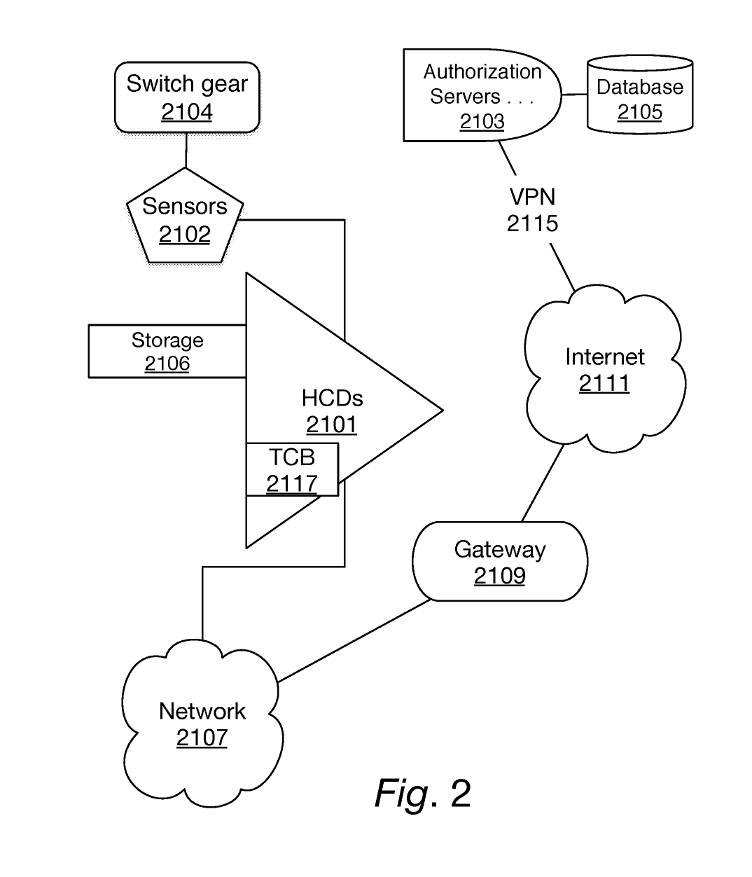

With reference to FIG. 2, an embodiment of the invention as applied to HCDs in a nuclear power plant reactor system will be described. Here, the HCDs are connected to sensors for monitoring power transmission switchgear directing energy over different power grids.

One or more HCDs 2101 on network 2107 are respectively connected to sensor bundles 2102 which provide respective signals from nuclear reactor switchgear 2104 that route energy to different electrical transmission networks of a power grid. Storage 2106, which is advantageously encrypted or protected, or both, is either external and engaged with, or internal to, each of the one or more HCDs and contains the operating system, application programs, and other data for the respective HCDs and provides access to memory for defense against cyberattacks. In a preferred embodiment storage 2106 is removeably engaged, and has a form factor of a USB flash drive. As will be evident to one of ordinary skill in the art, such storage could be any type of data repository known now or in the future, including drives, flash memory, or the like. In a further embodiment, storage 2106 is bootable. Network 2107 is also connected to a network gateway 2109 to convert the protocols of network 2107 to the protocol of the Internet 2111 over which one or more VPN connections 2115 are created to connect to one or more authorization servers 2103. Each authorization server controls a database 2105 containing the authentication parameters in the form of keys, PINs or passwords specific to HCDs 2101 log on policies.

HCDs 2101 (or any one or more of these) power up in pre-boot mode. Their individual boot loaders execute using the HCD's internal BIOS to connect to the network 2107 which passes the information through the network gateway 2109 to each of the authorization servers 2103 using the Internet 2111 as the transmission medium.

In one embodiment, the IP address of the one or more authorization servers is not known to the HCDs. In that case, gateway 2109 broadcasts out a UDP packet of information over the VPN connections 2115.

This broadcast packet contains a unique identifier which is composed of the serial number and public key of the broadcasting HCD. The authorization servers listen to incoming packets and when the identifier information matches an entry in their database they accept the packet, and otherwise reject the packet.

The server which has accepted the packet then uses a public key challenge response protocol (or other authentication protocol) to establish a secure point-to-point connection with the HCD. If successfully completed, a passcode is sent to the HCD so that it can complete the boot up to an operational state.

In a further embodiment, one or more of the HCDs may incorporate a trusted computer base TCB 2117 to protect critical security parameters. As with storage 2106, the TCB could be internal or external to the HCD. In a further embodiment, it could be removably engaged with the HCD, and in a still further embodiment could contain storage 2106. The TCB, broadly, is a set of cryptographic protection mechanisms that enforces a security policy so that access to resources such as storage for an operating system, programs and data, or computing resources, cannot be achieved unless specific rules and procedures are followed. The Trusted Computer System Evaluation Criteria from the United States Department of Defense (also referred to as the “Orange Book”) defines a TCB as “the totality of protection mechanisms within a computer system . . . the combination of which is responsible for enforcing a security policy. It creates a basic protection environment and provides additional user services required for a trusted computer system.” An appropriately designed cryptographic token can, for example, contain a TCB. Appropriate design might include features such as a tamper proof case, nonmodifiable firmware, and zeroization of sensitive data upon intrusion detection. A secure operating system is another example of a TCB.

Although superseded (e.g., by Common Criteria for Information Technology Security Evaluation) reference to the Orange Book will be understood by one skilled in the art with reference to this disclosure as a broad reference to that portion of a computing system which is responsible for enforcing a security policy.

If a TCB is employed it will require an access code to gain access to it, and this is a further example of the sort of information that could be passed down to the authenticated HCD by an authorization server.

Embodiments of the present invention may be implemented in hardware, or as software modules running on one or more processors, or in a combination thereof. That is, those skilled in the art will appreciate that special hardware circuits such as Application Specific Integrated Circuits (ASICs) or Digital Signal Processors (DSPs) may be used in practice to implement some or all of the functionality of all components of the present invention.

It should be noted that the described embodiments are exemplary rather than limiting the present invention. Substitute embodiments may be designed by those skilled in the art without departing from the scope of the claims enclosed.

1. A method for secure remote authentication of a computing device over a network that uses a communications protocol which does not require use of an address, and on which one or more authentication servers are listening, comprising the steps of:
a. broadcasting a unique identifier over the network;
b. accepting a request over the network from one of the one or more authorization servers to initiate an authentication protocol;
c. responding to the request;
d. receiving data necessary to complete a boot process; and
e. completing a boot process using the received data.

2. The method of claim 1, where the unique identifier is selected from the group of unique data consisting of a serial number, machine fingerprint data, a network authorization code, a public key, and a session nonce.

3. The method of claim 2, where the unique identifier further comprises a hash of the unique data.

4. The method of claim 1, the receiving step further comprising receiving program data.

5. The method of claim 1, the computing device having a trusted computing base requiring a passcode for access, and further comprising the step of receiving the passcode necessary to access the trusted computing base.

6. The method of claim 1, the computing device having a copy of its operating system in storage.

7. The method of claim 6, where the storage is an external flash drive removeably engaged with the device.

8. The method of claim 6, where the storage is internal to the device.

9. The method of claim 6, where the storage is bootable.

10. The method of claim 6, where the storage is encrypted.

11. The method of claim 6, where the storage is protected.

12. A method for secure remote authentication of a computing device over a network that uses a communications protocol which does not require use of an address, a gateway operably connected to both the network and the Internet for converting messages in the network protocol to a protocol useable on the Internet, or vice-versa, and one or more authorization servers listening on the Internet, comprising the steps of:
a. broadcasting a unique identifier over the network;
b. accepting a request over the network from one of the one or more authorization servers to initiate an authentication protocol;
c. responding to the request;
d. receiving data necessary to complete a boot process; and
e. completing a boot process using the received data.

13. The method of claim 12, where the unique identifier is selected from the group of unique data consisting of a serial number, machine fingerprint data, a network authorization code, a public key, and a session nonce.

14. The method of claim 13, where the unique identifier further comprises a hash of the unique data.

15. The method of claim 12, the receiving step further comprising receiving program data.

16. The method of claim 12, the computing device having a trusted computing base requiring a passcode for access, and further comprising the step of receiving the passcode necessary to access the trusted computing base.

17. The method of claim 12, the computing device having a copy of its operating system in storage.

18. The method of claim 17, where the storage is an external flash drive removeably engaged with the device.

19. The method of claim 17, where the storage is internal to the device.

20. The method of claim 17, where the storage is bootable.
